(19) United States
(12) Patent Application Publication
(10) Pub. No.: US 2009/0195127 A1
(43) Pub. Date: Aug. 6, 2009

(54) ELECTRIC GENERATOR

(75) Inventor: Yu-Liang Lin, Kaohsiung County (TW)

Correspondence Address: DLA PIPER LLP (US ), 2000 UNIVERSITY AVENUE, EAST PALO ALTO, CA, 94303-2248, US

(73) Assignee: YLC Precision Co., Ltd., Dashe Township (TW)

(21) Appl. No.: 12/107,712

(22) Filed: Apr. 22, 2008

(30) Foreign Application Priority Data
Feb. 1, 2008 (TW) 097202224

(51) Int. Cl. H02K 16/04; H02K 1/12; B62J 6/08; H02K 23/36

(52) U.S. Cl. 310/75 C; 310/184; 310/198

(57) ABSTRACT

An electric generator includes at least first and second stator units aligned along a stator axis, and a rotor. Each stator unit includes a stator core having a plurality of angularly spaced-apart coil mounting arms that extend in radial outward directions relative to the stator axis, a plurality of field coils each wound on a respective one of the coil mounting arms, and an insulator unit disposed between the field coils and the stator core so as to provide electrical insulation therebetween while permitting electromagnetic coupling therebetween. The first and second stator units are arranged side by side along the stator axis such that the coil mounting arms of the first stator unit are angularly displaced with respect to the coil mounting arms of the second stator unit. The rotor is coupled rotatably to the first and second stator units for inducing electrical currents in the field coils.

### BACKGROUND OF THE INVENTION

1. Field of the Invention

This invention relates to an electric generator, more particularly to an electric generator that is adapted for contacting a rotary object, e.g., a wheel of a bicycle.

2. Description of the Related Art

FIGS. 1 and 2 illustrate a conventional electric generator disclose in Taiwanese Utility Model Publication No. 347171. The electric generator is coupled to a wheel 100 of a bicycle to generate electrical energy and includes a wheel axle 11 for mounting rotatably the wheel 100, a stationary shaft unit 12 sleeved on the wheel axle 11, a plurality of stators 13 sleeved on the stationary shaft unit 12, and a housing 14 mounted on the wheel 100 and surrounding the stators 13. Each stator 13 has a stator mount unit 131 disposed on the stationary shaft unit 12, a field coil 132 wound on the stator mount unit 131, and a pair of opposite electrode plates 133 disposed at opposite sides of the stator mount unit 131. The housing 14 is provided with a plurality of annular magnet units 141 at its inner surface. Each annular magnet units 141 surrounds a respective one of the stators 13.

When the wheel 100 rotates, the annular magnet units 141 rotate relative to the stators 13. Due to the fact that the stationary shaft unit 12 and the stators 13 do not rotate relative to the wheel 100, when the housing 14 rotates with the wheel 100, interaction between the annular magnet units 141 and the stators 13 induces electrical currents in the field coils 132. The electrical currents can be subsequently outputted to power electronic devices using a power supply line 200. However, when the north and south poles of the annular magnet units 141 move relative to the stators 13, magnetic inertial forces are generated to thereby cause the housing 14 to vibrate sporadically. As expected, riders of the bicycle would also experience such vibration, which would affect the comfortability of a bicycle ride.

Moreover, even though the conventional electric generator is capable of boosting the capacity of the electrical currents by using a plurality of stators 13, as the electrical current increases, so does ripple noises. The ripple noises tend to destabilize the electrical currents when the latter one are supplied to other devices.

### SUMMARY OF THE INVENTION

The object of the present invention is to provide an electric generator that can overcome the above drawbacks of the prior art.

According to the present invention, an electric generator includes at least first and second stator units aligned along a stator axis, and a rotor. Each stator unit includes a stator core having a plurality of angularly spaced-apart coil mounting arms that extend in radial outward directions relative to the stator axis, a plurality of field coils each wound on a respective one of the coil mounting arms, and an insulator unit disposed between the field coils and the stator core so as to provide electrical insulation therebetween while permitting electromagnetic coupling therebetween. The first and second stator units are arranged side by side along the stator axis such that the coil mounting arms of the first stator unit are angularly displaced with respect to the coil mounting arms of the second stator unit. The rotor is coupled rotatably to the first and second stator units for inducing electrical currents in the field coils when the rotor rotates relative to the first and second stator units about the stator axis.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional electric generator disclosed in Taiwanese Utility Model Publication No. 347171;

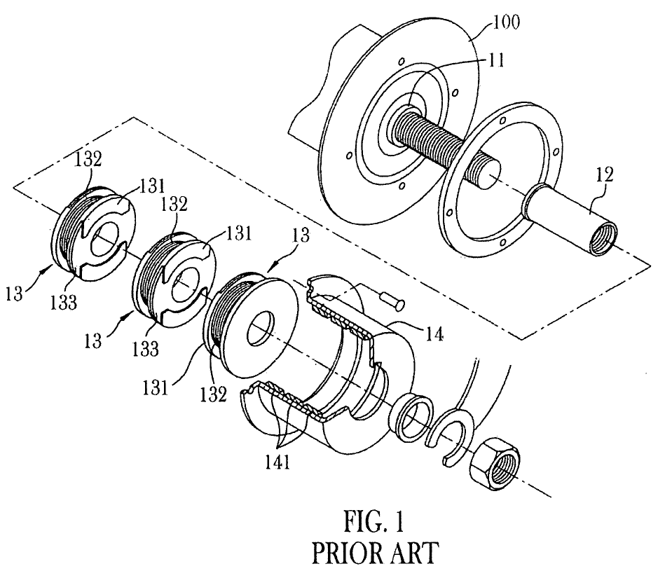

FIG. 2 is a cross-sectional view of the electric generator shown in FIG. 1, illustrating the electric generator in a state assembled onto a wheel;

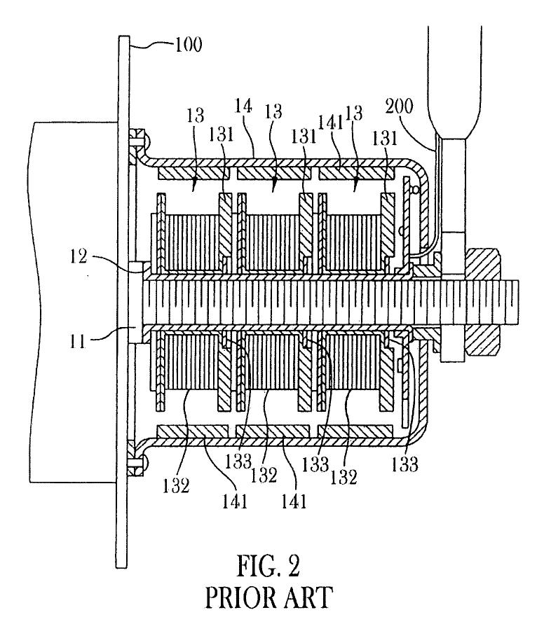

FIG. 3 is a perspective view illustrating the stator units and a coupling base of the preferred embodiment of an electric generator according to the present invention;

FIG. 4 is a schematic view of the electric generator of the preferred embodiment in an assembled state; and

FIG. 5 is a cross-sectional view of the preferred embodiment.

### DETAILED DESCRIPTION OF THE PREFERRED EMBODIMENT

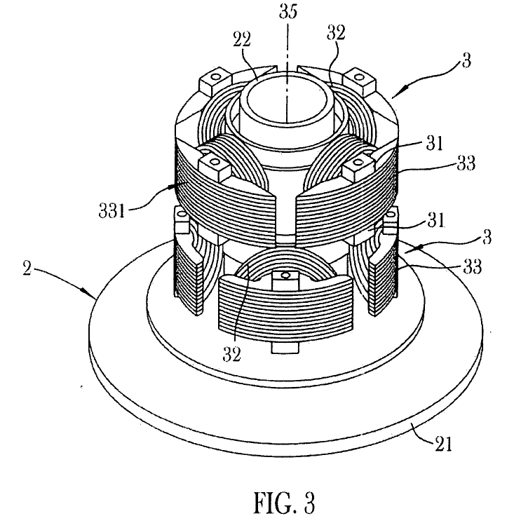

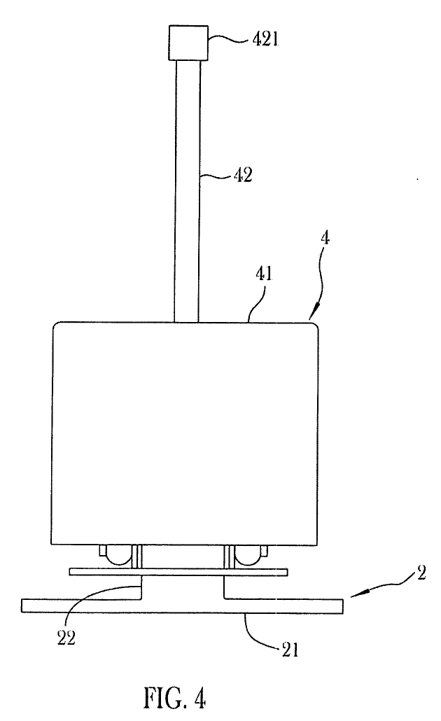

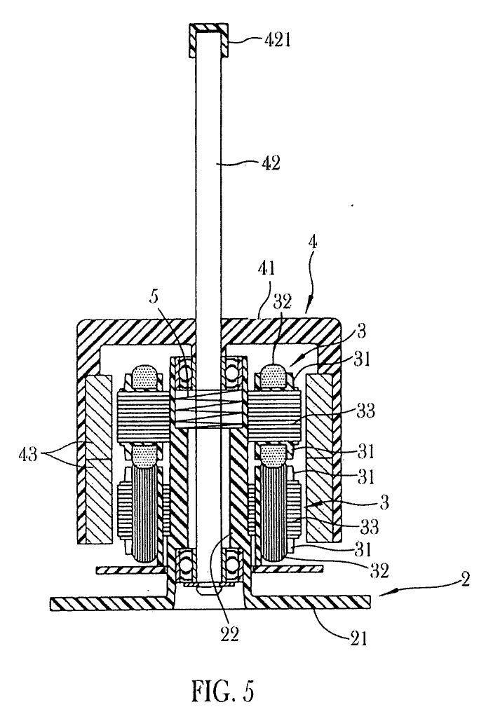

Referring to FIGS. 3, 4, and 5, the preferred embodiment of an electric generator according to the present invention includes at least first and second stator units 3 aligned along a stator axis 35, a coupling base 2, a spring 5, and a rotor 4. It should be noted only two stator units 3 (first and second stator units) are employed herein to explain the operation of the present invention.

Each stator unit 3 includes a stator core having a plurality of angularly spaced-apart coil mounting arms 33 that extend in radial outward directions relative to the stator axis 35, a plurality of field coils 32 each wound on a respective one of the coil mounting arms 33, and an insulator unit 31 disposed between the field coils 32 and the stator core so as to provide electrical insulation therebetween while permitting electromagnetic coupling therebetween. The first and second stator units 3 are arranged side by side along the stator axis 35 such that the coil mounting arms 33 of the first stator unit 3 are angularly displaced with respect to the coil mounting arms 33 of the second stator unit 3. Preferably, the stator core of each of the first and second stator units 3 is formed from a stack of silicon steel plates 331.

The rotor 4 includes a rotor housing 41, a rotor shaft 42, and first and second annular magnet units 43. The rotor housing 41 surrounds the first and second stator units 3. The rotor shaft 42 is coupled non-rotatably to the rotor housing 41 and extends along the stator axis 35. Each of the first and second annular magnet units 43 is mounted to an inner surface of the rotor housing 41 and is disposed to surround a respective one of the first and second stator units 3. The rotor 4 is coupled rotatably to the first and second stator units 3 for inducing electrical currents in the field coils 32 when the rotor 4 rotates relative to the first and second stator units 3 about the stator axis 35.

The coupling base 2 couples the rotor 4 rotatably to the first and second stator units 3. The coupling base 2 includes a base part 21 and a tubular shaft 22 that extends perpendicularly from the base part 21 and that extends along the stator axis 35. The stator cores of the first and second stator units 3 are sleeved on the tubular shaft 22. The rotor shaft 42 of the rotor 4 extends into and is coupled rotatably to the tubular shaft 22 via bearings.

In this embodiment, the rotor shaft 42 has an end part 421 that extends outwardly of the rotor housing 41, and that is adapted for contacting a rotary object (e.g. a wheel of a bicycle) such that rotation of the rotary object results in corresponding rotation of the rotor 4 about the stator axis 35, thereby resulting in a conversion of mechanical energy into electrical energy.

The spring 5 is disposed in the tubular shaft 22 and is sleeved on the rotor shaft 42. The spring 5 has opposite ends that act on the tubular shaft 22 and the rotor shaft 42, respectively to thereby serve as a buffer or shock damper between the rotor 4 and the tubular shaft 22.

In this embodiment, the stator core of each of the first and second stator units 3 has four of the coil mounting arms 33, and the coil mounting arms 33 of the first stator unit 3 are displaced with respect to the coil mounting arms 33 of the second stator unit 3 at 45-degree angles. In addition, two separate stator units 3 in a side by side configuration are utilized to achieve a current output that is theoretically two times the magnitude of the current output when only one stator unit 3 is used. However, this invention is not limited to such a configuration. That is, the magnitude of the current output is proportional to the number of the stator units 3 used. As an example, if it is desirable to acquire a current output that is three times the magnitude of the current output of a single stator unit 3, then three individual stator units 3 are utilized instead of two, and the coil mounting arms 33 of each of the stator units 3 will be displaced at 30-degree angles with respect to the coil mounting arms 33 of the adjacent stator unit 3.

When is in use, the wheel of the bicycle drives the rotor shaft 42 to thereby cause rotation of the rotor housing 41. In this state, the first and second annular magnet units 43 of the rotor 4 would interact correspondingly with the first and second stator units 3 to induce electrical currents in the field coils 32. The induced electrical currents can be subsequently outputted to power other devices (e.g., a headlamp) via a power supply line (not shown).

In this embodiment, since the coil mounting arms 33 of the first stator unit 3 are angularly displaced with respect to the coil mounting arms 33 of the second stator unit 3, the magnetic fields sensed by the field coils 32 of the stator units 3 when the rotor 4 rotates are not in phase. As a result, a lesser degree of the magnetic inertial forces are generated, which in turn, results in less sporadic vibrations. Moreover, because the magnetic fields sensed by the field coils 32 of the stator units 2 are no in phase, the ripple noises in the electrical currents can cancel out, so that amore stable current output can be obtained.

Unlike the conventional electric generator described hereinabove, the electric generator of the present invention is not required to be mounted onto a wheel. By mounting the electric generator of this invention on a frame via a movable mounting seat (not shown), contact between the wheel and the rotor shaft 42 can be disabled when it is not required to use the electric generator.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An electric generator comprising:
at least first and second stator units aligned along a stator axis, each of said first and second stator units including
a stator core having a plurality of angularly spaced-apart coil mounting arms that extend in radial outward directions relative to said stator axis,
a plurality of field coils each wound on a respective one of said coil mounting arms, and
an insulator unit disposed between said field coils and said stator core so as to provide electrical insulation therebetween while permitting electromagnetic coupling therebetween,
said first and second stator units being arranged side by side along said stator axis such that said coil mounting arms of said first stator unit are angularly displaced with respect to said coil mounting arms of said second stator unit; and
a rotor coupled rotatably to said first and second stator units for inducing electrical currents in said field coils when said rotor rotates relative to said first and second stator units about said stator axis.

2. The electric generator as claimed in claim 1, wherein said rotor includes:
a rotor housing that surrounds said first and second stator units;
a rotor shaft that is coupled non-rotatably to said rotor housing and that extends along said stator axis; and
first and second annular magnet units each of which is mounted to an inner surface of said rotor housing and is disposed to surround a respective one of said first and second stator units.

3. The electric generator as claimed in claim 2, further comprising a coupling base for coupling rotatably said rotor to said first and second stator units, said coupling base including a base part and a tubular shaft that extends perpendicularly from said base part and that extends along said stator axis, said stator cores of said first and second stator units being sleeved on said tubular shaft, said rotor shaft of said rotor extending into and being coupled rotatably to said tubular shaft.

4. The electric generator as claimed in claim 2, wherein said rotor shaft has an end part that extends outwardly of said rotor housing and that is adapted for contacting a rotary object such that rotation of the rotary object results in corresponding rotation of said rotor about said stator axis.

5. The electric generator as claimed in claim 3, further comprising a spring disposed in said tubular shaft and sleeved on said rotor shaft, said spring having opposite ends that act on said tubular shaft and said rotor shaft, respectively.

6. The electric generator as claimed in claim 1, wherein said stator core of each of said first and second stator units has four of said coil mounting arms, and said coil mounting arms of said first stator unit are displaced with respect to said coil mounting arms of said second stator unit at 45-degree angles.

7. The electric generator as claimed in claim 1, wherein said stator core of each of said first and second stator units is formed from a stack of silicon steel plates.
